(19) United States
(12) Patent Application Publication
(10) Pub. No.: US 2005/0240653 A1
(43) Pub. Date: Oct. 27, 2005

(54) Integrated telecommunications/office automation apparatus, system, and computer program product

(75) Inventor: Thomas F. Anglero, Oslo (NO)

Correspondence Address: OBLON, SPIVAK, MCCLELLAND, MAIER & NEUSTADT, P.C., 1940 DUKE STREET, ALEXANDRIA, VA, 22314, US

(73) Assignee: TELENOR ASA, Fornebu (NO)

(21) Appl. No.: 11/106,592

(22) Filed: Apr. 15, 2005

Related U.S. Application Data
(60) Provisional application No. 60/564,575, filed on Apr. 23, 2004.

(51) Int. Cl. G06F 15/16

(52) U.S. Cl. 709/203

(57) ABSTRACT

Plug-in or other code allows for telecommunications services to be accessed from within an office automation software environment. Monitoring of a user processing a document of an office application recognizes user input of a smart tag featured character string and/or a research panel menu selection to call a selected program to request a telecommunications service associated with the recognition.

### CROSS REFERENCE TO RELATED APPLICATIONS

The present application claims priority to provisional patent application 60/564,575, filed on Apr. 23, 2004. The present application is related to utility application Ser. No. 10/921,971, filed on Aug. 20, 2004, the entire contents of which are hereby incorporated by reference.

### BACKGROUND OF INVENTION

1. Field of Invention

The present invention relates to the field of computer office applications that provide varied computer functionality to a user, particularly the processing of a document. The present invention further relates to the field of providing telecommunications services to a client. The present invention also relates to the field of requesting and receiving information over computer accessed networks.

2. Discussion of the Background Art

Document processing is performed by office applications (e.g. office suites including accounting programs, graphics programs, web page creating programs, word processing programs, spreadsheet programs, etc), which may be wholly or partially resident locally or remotely with respect to a local user operating a computer within a broader computer system. Such document processing is well known and at times generates a document display for the user.

These office applications for document processing have offered a certain amount of integration between them in the sense that data created in one application can be embedded in a document created in another application, and the embedded data will be sent back to the original application for further modification or editing in the original application if the user clicks on the part of the document containing the embedded data.

Some document processing applications are capable of accessing e-mail client programs so that the user can enter the e-mail address of a recipient and send the document by e-mail, thereby closing the document processing application and opening the e-mail program instead, with the text being transferred through, for example, a clipboard. If further document processing is desired, the document processing application must then be re-launched by the user.

Some document processing uses hypertext. Hypertext, as originally envisioned in 1965, associated textual elements in documents to be linked. Currently, “hypertext” is associated with the World Wide Web (www) and the Hypertext Markup Language (HTML) language. For example, clicking on a text of a different color (the hypertext) will transport you to another sentence, paragraph or section that may explain the text for document processing. As a further example, clicking on a text of a different color (the hyperlink) will transport you to another webpage that may be related to the current web page, for use on the World Wide Web (www).

Some computer applications enable identification of certain portions of data within a document, particularly character strings, to provide these portions of data with so-called tags that contain information describing some characteristic of the data portions. As an example, Microsoft Corp. has provided such functionality in their Office applications. In Office this functionality is known as SmartTags, their version of a smart tag feature. To add SmartTags, an author can use a text editor such as Notepad or an HTML editor such as Microsoft FrontPage® 2002. Users may add SmartTags by installing them (running an installation program for the new smart tag functionality), or enabling them in the options menu of the Office application if the SmartTag is already installed. A Smart Tag may be defined as a browser plug-in that recognizes words and phrases on Web pages and automatically turns them into links to advertisers or dictionary/encyclopedia definitions.

To view smart tag functionality, users must have predetermined software installed on their computers (e.g., Office XP, or some versions of Microsoft Internet Explorer (IE)) and the appropriate smart tag Dynamic Link Library (DLL) or smart tag Extensible Markup Language (XML) list description file. The user can configure SmartTags to identify character strings defined by the user. Certain actions can be associated with each type of SmartTag. When a user clicks on a character string tagged with a SmartTag in a Microsoft Office document, a short cut to a web or other address is activated. The developer of the SmartTag may determine the character strings to be recognized.

The term, “character string”, as used herein, includes text and more broadly any code sequence, including one or more of, e.g., ASCII, text, logos, symbols, digits, and dashes, or a name present in an address book.

Implementations of SmartTags have been limited to recognition of names, email addresses and other contact information for integration with applications such as Outlook. SmartTags have also been used to recognize codes/IDs, such as product codes, for adding more information about an item (product) in a document.

In Office 2003, if a user looks up the word Mississippi and right clicks, a SmartTag enables a thesaurus to give synonyms or antonyms of that word: this is and example of a smart tag feature that a third party company other than Microsoft has embedded within Microsoft Office 2003. In Internet Explorer, if a web page has appropriate technology, a paragraph will pop up when the mouse is over that word; this is similar to a smart tag feature, particularly when you click on the paragraph to launch a web page.

Telecommunications services are provided to a client of a telecommunications services provider, for example a public telephone services company, such as Telenor of Norway. These telecommunications services providers have a recognized need to not only expand their services, but also to make their existing services more accessible to their clients, which-in turn will to a great extent determine client needs for such expansion. The telecommunications services providers operate separately from internet-enabled services such as web-based or application based telecommunications services.

Information is commonly requested and supplied in response to such requests over networks accessed by a computer user, for example through a web browser and a search engine. Such networks include the World Wide Web (www) and more generally the Internet of which the www is a part. Portions of the www use telecommunication transmissions, e.g. networks including landlines, satellites, fiber optics, cellular facilities and other wireless links. Web pages have used hyperlinks to associate text with individual resources on a file system, web server, or e-mail server. The hyperlink associates one part of a page on the Internet to another page, either on the same site or at a distant site. The user remains connected in a Web session through spooling.

It is recognized that a need exists to integrate services and equipment that are associated with a user computer, a telecommunications network, the internet and www, and the functions of discrete computer applications, all within a computer system.

### SUMMARY OF THE INVENTION

Direct accessing of telecommunications services from within an office application with document processing capabilities is an object or the present invention.

For example, a plug-in (code having a smart tag feature and control for a browser to operate within an office suite type application) identifies character strings in a document and enables accessing a remote telecommunications services provider using the character string as a representation of or key to address information used to reach the telecommunications services provider and preferably also to identify services requested. Thereby, smart tag functionality enables close integration of an office application and telecommunications services conveniently to enhance the application users experience. As a result, this will drive revenues for telecommunications services providers by boosting use of telecommunications services.

Smart tag features have not been used with telecommunications functions. Conventional implementations of smart tag features do not directly interact with telecommunications services.

If a user operating a word processing program wants to exercise a telecommunications function (e.g., to send a Short Message Service (SMS) message), a separate application must be activated, resulting in leaving the word processing program/application.

The present invention expands a user's possibilities for accessing telecommunications services without leaving the user's office application environment.

In the embodiment, the above-mentioned object and advantages are achieved through the use of code, e.g. a plug-in in the office application and/or a plug-in for a browser and existing user applications and utilities. The plug-in enables the browser functions to be used within the office application program/application, to enable detecting a character string in a document. Detection occurs, for example, when the character string exhibits a pattern consistent with a telephone number or a key to a telephone number. Upon detection, the embodiment provides smart tag functionality for this detected character string according to or in response to what is detected. The smart tag feature associated with messaging software will open the messaging software when a user clicks (herein used broadly to refer to accessing a function associated with the character string, for example by single or double clicking the character string with a mouse, pointer or optical pen, or using one or more keyboard strokes with respect to a curser location) on the tagged character string. Thereby, the character string or information identified or associated with the character string is sent to the messaging software as a parameter.

By way of example, when a character string associated with-a smart tag feature for messaging is detected, the messaging software opens with the character string in the “to” field. The user will then be able to simply enter a message and activate the send function of the messaging software, all within the office application. The messaging software is preferably pre-configured to hold any login information necessary in order to access the telecommunications services provider. The login information will typically include the users phone number, and the telecommunications services provider will be able to charge the communication to this number.

The web-services model of the present invention preferably uses standardized programming languages such as extensible mark-up language (XML) to make integrating disparate systems cheaper and more immediate. The embodiment allows users to access elements of its fixed, mobile, online and satellite broadcasting services from within office applications such as Word, Excel, Outlook and PowerPoint via this plug-in, something that has not been achieved to date.

As an example usage, a telecommunications customer/client composing or editing a document as a user of a document processing application (Microsoft's Word, for an example office application) queries the user's directory service, finds someone's phone number and then sends that person a Multimedia Message Service (MMS) with the letter attached, all from within the document processing application. Revenue for the telecommunications services provider is, for example, generated from the standard charges that the telecommunications services provider applies for sending MMS or SMS messages.

Other services that may be accessed with the present invention, such as the operator/user's online news service, e-commerce account (in the embodiment called “mCommerce”), TV guide and directory services, may be fee-based or free to access. The present invention boosts consumer use of a telecommunications services provider's free and fee-based services, and attracts new subscribers, customers and clients in a domestic and international telecommunications market. The invention has applicability to a service provider's business and private customers.

From a review of the problems and causes of such problems relating to each of the fields of document processing, telecommunications services and information retrieval, as made by the present inventor, the inventor has discovered a need for a method and apparatus that enables direct access to telecommunications services (e.g., through recognition of a telephone number) from within document processing applications, so as to provide greater convenience for the user (e.g., direct calling and sending of SMS or MMS messages) and to boost use of telecommunications services and drive revenues for telecommunications services providers.

Further objects, features and advantages of the present invention will become more apparent from the following detailed description of a preferred embodiment, which is also the best mode of practicing the invention.

### BRIEF DESCRIPTION OF THE DRAWINGS

The exemplary embodiment is described with respect to the drawing, wherein:

FIG. 1 is a block diagram of a computing system according to a preferred embodiment of the present invention;

FIG. 2 is a flow chart of software interactions according to the embodiment of FIG. 1;

FIG. 3 is a screen snap shot on the user's display of FIG. 1, showing an example document of an office application, which document has one or more character strings that each have a smart tag feature, and further showing a research pane/window for a specific Telecommunications Services Provider, which window was generated/launched by activating one of the smart tag features;

FIG. 4 is a screen shot generated in response to a user menu selection “Send SMS/MMS” made from a menu in the research pane of the FIG. 3 screen shot, which illustrates an example SMS/MMS smart tag feature;

FIG. 5 is a screen shot generated in response to a user menu selection “Send SMS” made from the FIG. 4 screen shot illustrating an example SMS smart tag feature;

FIG. 6 is a screen shot showing an example TV-Guide service provided by the telecommunications services provider to a user's display, which was accessed by a smart tag feature from within a document-on the user's display, for example, by a user's successive choices from the research pane menu items, namely “TV-Guide”/“Showing now”, from the FIG. 3 display; and

FIG. 7 is a screen shot showing an example mobile commerce service (mCommerce) provided by the telecommunications services provider to a user's display, which was accessed by a smart tag feature from within a document on the user's display, for example, by a user choice of the menu item “Register for mCommerce”, from the FIG. 3 display or one of the other displays where available.

### DETAILED DESCRIPTION OF THE INVENTION

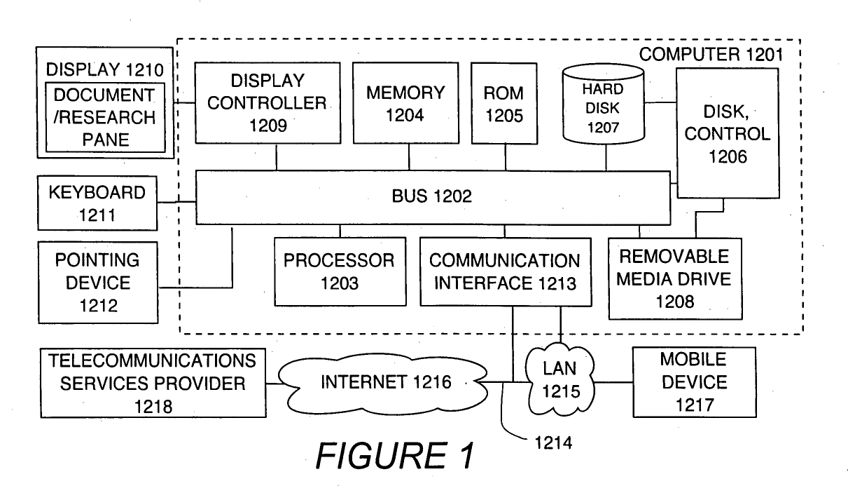

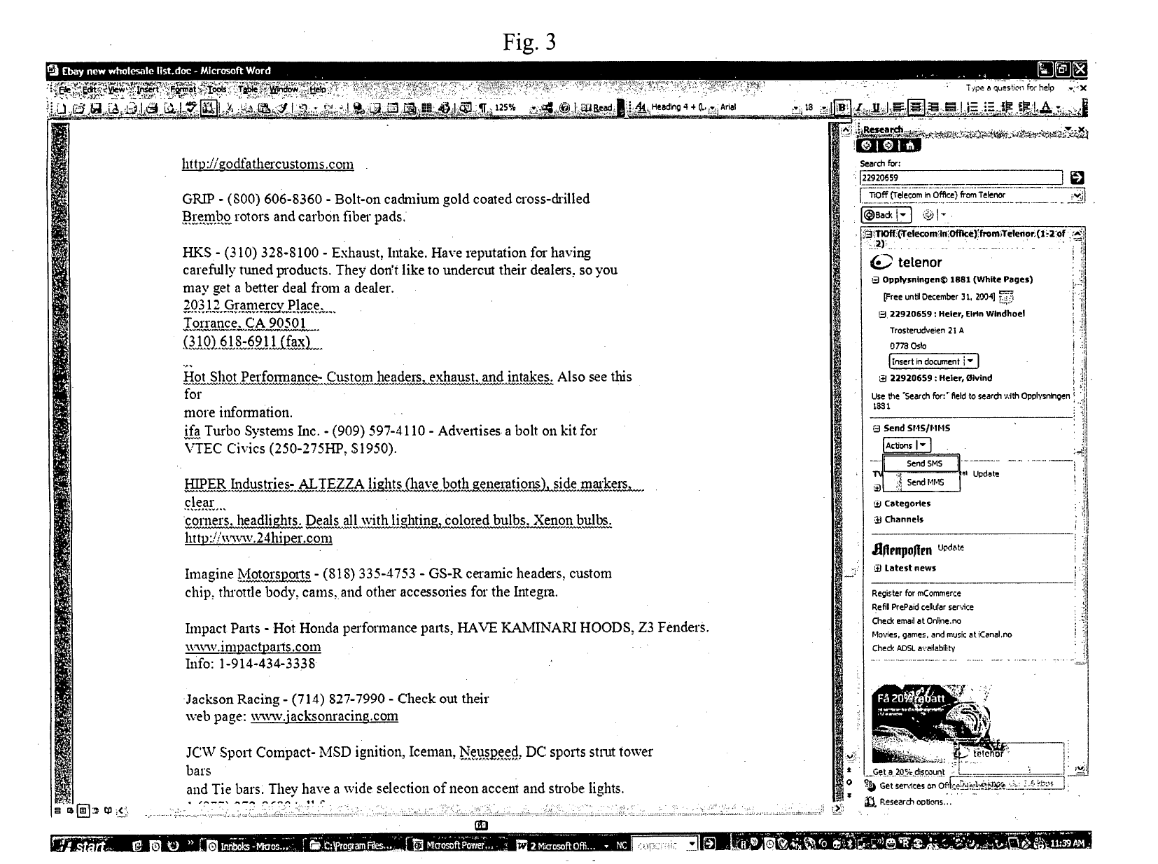

FIG. 3 is a screen snap shot of one embodiment of the present invention, which screen snap shot is taken from the monitor or display 1210 of the FIG. 1 computer system 1201. In the center of the desktop is a display from the running of a document processing application. To the left of the display is a word processing document. To the right of the display is a research pane or window, which is a gateway through which an operator of the display can interact with a variety of telecommunications services. These multiple web services exposed within the research pane include: a) a white pages search; b) a map-it function; c) a Short Message Service (SMS) function; d) a news function; e) a television/radio guide; f) an asymmetric digital subscriber line (ADSL) checking function (looking up whether or not a phone number can provide Digital Subscriber Line (DSL) service at that address and location and that goes to another business); g) a yellow page search, and h) a Multimedia Message Service (MMS); and links to external websites.

The smart tag feature of the embodiment initiates either through automatic recognition of the presence of a pre-encoded character string in the office application document or via user selection and smart tag feature encoding and selection of a character string within the document, both during running of the office application. Initiating the smart tag feature contacts the associated Telecommunications Services Provider to provide an up-to-date research pane via the Internet. The research pane provides, for example, a drop down menu as shown in FIG. 3.

When a telephone number is detected (literally or by a pattern) and verified from a character string within the word processing document, the character string is tagged by the plug-in that has the smart tag feature, a research page from the Telecommunications Services Provider identified by the character string is displayed within the office application, and then the operator/user is able to select from a variety of smart tag accessed options, such as, a) send SMS, b) remove this smart tag and c) stop recognizing the number. Further examples of smart tag accessed options include performing a directory search from the phone number provided, setting up a phone call between a mobile/fixed phone to the user's mobile, displaying a list of services in the form of webpage links to a host telecommunications service provider's web pages from within the smart tag feature, and querying the identified phone number to determine if broadband services are available at that phone number (ADSL, defined later).

The preferred embodiment uses Extensible Markup Language (XML) capabilities, which are built into many conventional office document processing applications and accompanying utilities, to integrate these office applications with fixed, mobile and online services, which have been made available as web services using XML. The embodiment plug-in, having smart tag features, is based on standard XML technology. Details about SmartTag implementation, which may be used in the embodiment, are well known and provided by Microsoft at there website and in readily available SmartTag documentation. The present invention is adapted to known office automation environments and known smart tag features, other than those provided by Microsoft, by using ordinary skill in the art.

The embodiment enables use of a smart tag feature, such as the Microsoft SmartTags, from within an office software environment, for example Microsoft's Office, to access services over the Internet from a Telecommunications Services Provider 1218 of FIG. 1. When the smart tag feature identifies a phone number, for example through recognition of a character string that has the character groupings that are characteristic of a phone number, the bound smart tag feature directs access to an application, such as a browser, from which a service is requested, for example, an SMS can be sent using the telecommunications services provider's services. Further, the embodiment may verify that the recognized number is in the user's address book before offering direct access to the corresponding service of the Telecommunications Services Provider 1218. As a farther feature, the smart tag feature identifies a potential name, for example through recognition of a character string that has the characteristic groupings of capitalized words, and then verifies the name as a name associated with a phone number or address of a Telecommunications Services Provider 1218 in the user's address book, before offering direct access.

The smart tag feature launches the telecommunications service, for example an SMS application using a NET API call for starting .exe files. The recognized phone number (either directly recognized from the document as being associated with a smart tagged character string or indirectly recognized through an address book and a recognized name type character string subsequently verified) is passed as a parameter to the .exe file. The code for this is exemplified by systems.diagnostics.process.start (smsappexe, phonenr).

The office environment allows registered smart tag features access to document data through real time monitoring during running of the office application. The smart tag feature is continuously fed the contents of the document while the user enters, edits such contents from within the office application, for example through the keyboard 1211 of FIG. 1, or simply views the contents. Using the functionality of regular expressions in a NET API, the office application is notified so that the recognized character string is marked as recognized by the smart tag feature. When the user selects a specific smart tag feature from the marked text, a service is launched, for example the SMS application is launched and the recognized character string (for example, the recognized phone number) is passed to the SMS application. The SMS application forwards the telephone number to a telecommunications gateway.

Additional services are offered upon recognition of a character string. These additional services include MMS (including sending the office document as an attachment), directory services, and more traditional web services like news, TV guide and weather. It is further envisioned to base the response from these services on context information embedded in smart tags features.

The embodiment enables an office application user to choose to call another person from within an office application (using smart tag features and the research pane), which will enable communication with telecommunications services on the Internet. The request will be relayed the to the telecom network. Here a phone call connection between the user and the remote telephone will be established and both telephones will ring. Note that while in the first case the application is only sending a message from the Internet to the telecom net, in this second case a connection is established between terminals on the telecom net based on a request from the Internet (telecom signaling over Internet). The call will be connected via the standard Telecom infrastructure, with the Internet as the transport medium for the signal to establish the call on the telecom network.

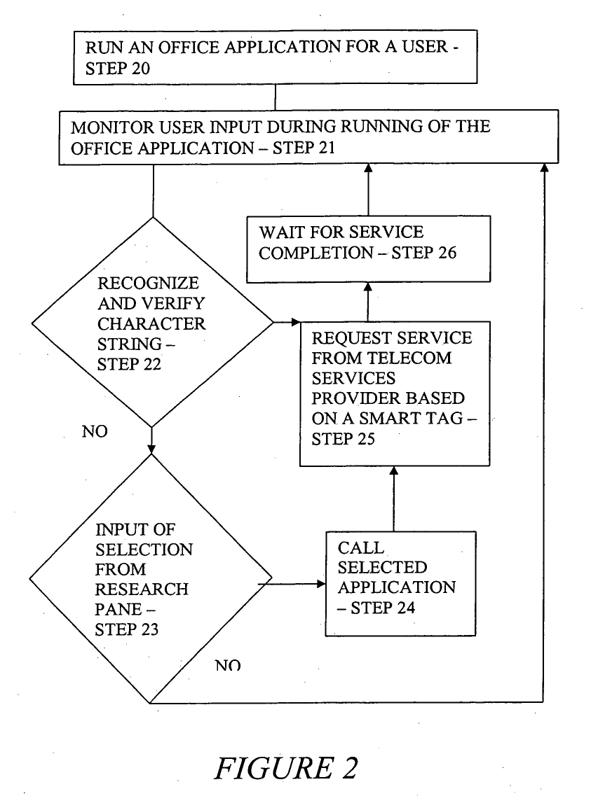

FIG. 2 is a flow chart corresponding to the embodiment of the present invention. When the monitoring application is enabled (STEP 21) during running of an office application for a user (STEP 20), the telecommunications service process begins when the browser plug-in detects one character string in the document out of one or more predefined character strings. Then the detected character string is smart tagged to be associated with a specific Telecommunications Services Provider 1218, for example associated to a phone number, preferably after verification (STEP 22). The character string may be an actual phone number, an entity's name, an address, or any other nickname/identifier previously determined by the user.

The user clicks on the tagged character string to cause display of an appropriate one or additionally other menu options or the display may be automatic upon recognition in Step 22 or a pre-display as a part of Step 21. From the menu of options, the user selects, for example, one of a) SMS, b) MMS, or c) to set up a phone call (STEP 23). If SMS is chosen, for example, a messaging application/window is opened and the number is sent to the messaging application (STEP 24). The user then enters the message and clicks to send (STEP 25). If MMS is chosen, by way of another example, a messaging application/window is opened and the number is sent to the messaging application (STEP 24). The user then enters the message, edits the multimedia message or attaches a file, and clicks to send (STEP 25). After the user clicks to send in Step 25, the message is formatted and sent to a messaging server for forwarding to the destination address while request monitoring waits for completion of the requested service from the Communications Services Provider 1218 (STEP 26).

If the user selected to set up a phone call in Step 23, the calling number and called number are sent to a server (STEPS 24, 25), and the call is placed while the application awaits completion of the service (STEP 26).

Upon completion of the services, Step 26 returns control to the monitoring Step 21 and the user may continue using the office application running in Step 20. Preferably, Steps 22 and 23 have an allotted time for completion (time-out), which when exceeded results in return to the monitoring Step 21. As would be known to an ordinarily skilled programmer, another time-out, cancel or back buttons and the like may be provided for user friendliness wherever desired.

Thus, from within an office automation office document processing software environment such as a word processor, a spreadsheet, a presentation package or other applications, telecommunications services can be quickly accessed and exercised.

FIG. 1 illustrates an exemplary computer system 1201 that implements the preferred embodiment of the present invention. The computer system 1201 includes a bus 1202 or other communication mechanism for communicating information, and a processor 1203 coupled with the bus 1202 for processing the information. The computer system 1201 also includes a main memory 1204, such as a random access memory (RAM) or other dynamic storage device (e.g., dynamic RAM (DRAM), static RAM (SRAM), and synchronous DRAM (SDRAM)), coupled to the bus 1202 for storing information and instructions to be executed by processor 1203. In addition, the main memory 1204 may be used for storing temporary variables or other intermediate information during the execution of instructions by the processor 1203. The computer system 1201 further includes a read only memory (ROM) 1205 or other static storage device (e.g., programmable ROM (PROM), erasable PROM (EPROM), and electrically erasable PROM (EEPROM)) coupled to the bus 1202 for storing static information and instructions for the processor 1203.

The computer system 1201 also includes a disk controller 1206 coupled to the bus 1202 to control one or more storage devices for storing information and instructions, such as a magnetic hard disk 1207, and a removable media drive 1208 (e.g., floppy disk drive, read-only compact disc drive, read/write compact disc drive, compact disc jukebox, tape drive, and removable magneto-optical drive). The storage devices may be added to the computer system 1201 using an appropriate device interface (e.g., small computer system interface (SCSI), integrated device electronics (IDE), enhanced-IDE (E-IDE), direct memory access (DMA), or ultra-DMA).

The computer system 1201 may also include special purpose logic devices (e.g., Application Specific Integrated Circuits (ASICs)) or configurable logic devices (e.g., Simple Programmable Logic Devices (SPLDs), Complex Programmable Logic Devices (CPLDs), and Field Programmable Gate Arrays (FPGAs)).

The computer system 1201 may also include a display controller 1209 coupled to the bus 1202 to control a display 1210, such as a cathode ray tube (CRT) or Liquid Crystal Display (LED), for displaying information to a computer user. The computer system includes input devices, such as a keyboard 1211 and a pointing device 1212 or others (not shown) such as a light pen, for interacting with a computer user and providing information (input) to the processor 1203. The pointing device 1212, for example, may be a mouse, a trackball, or a pointing stick for communicating direction information (input) and command selections (input) to the processor 1203 and for controlling cursor movement on the display 1210. In addition, a printer (not shown) may provide printed listings of data stored and/or generated by the computer system 1201.

The computer system 1201 performs a portion or all of the processing steps of the invention in response to the processor 1203 executing one or more sequences of one or more instructions contained in a memory, such as the main memory 1204, or stored elsewhere in the computer system 1201 or outside the computer system and accessible through a communication interface 1213 to a network such as the LAN 1215 or the Internet 1216, which includes the WWW (World Wide Web).

Such instructions may be read into the main memory 1204 from another computer readable medium, such as a hard disk 1207 or a removable media drive 1208. One or more processors in a multi-processing arrangement may also be employed to execute the sequences of instructions contained in main memory 1204. In alternative embodiments, hard-wired circuitry may be used in place of or in combination with software instructions. Thus, embodiments are not limited to any specific combination of hardware circuitry and software.

As stated above, the computer system 1201 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read such as the bus or connecting lines that temporarily hold such instructions.

Stored on any one or on a combination of computer readable media, the present invention includes software for controlling the computer system 1201, for driving a device or devices for implementing the invention, and for enabling the computer system 1201 to interact with a human user (e.g., print production personnel). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 1203 for execution. A computer readable medium may take many forms, including but not limited to, non-volatile media (e.g. 1205), volatile media (e.g. 1204), and transmission media (e.g. 1214, 1202). Non-volatile media includes, for example, optical, magnetic disks, and magneto-optical disks, such as the hard disk 1207 or the removable media drive 1208. Volatile media includes dynamic memory, such as the main memory 1204. Transmission media includes coaxial cables, copper wire and fiber optics, including the wires that make up the bus 1202. Transmission media also may also take the form of acoustic or light waves, such as those generated during radio wave and infrared data communications.

Various forms of computer readable media may be involved in carrying out one or more sequences of one or more instructions to processor 1203 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 1201 may receive the data on the telephone line and use an infrared transmitter to convert the data to an infrared signal. An infrared detector coupled to the bus 1202 can receive the data carried in the infrared signal and place the data on the bus 1202. The bus 1202 carries the data to the main memory 1204, from which the processor 1203 retrieves and executes the instructions. The instructions received by the main memory 1204 may optionally be stored on storage device 1207 or 1208 either before or after execution by processor 1203.

The computer system 1201 also includes a communication interface 1213 coupled to the bus 1202. The communication interface 1213 provides a two-way data communication coupling to a network link or transmission line 1214 that is connected to, for example, a local area network (LAN) 1215, or to another communications network 1216 such as the Internet or the World Wide Web (www).

For example, the communication interface 1213 may be a network interface card to attach to any packet switched LAN 1215. As another example, the communication interface 1213 may be an asymmetrical digital subscriber line (ADSL) card, an integrated services digital network (ISDN) card or a modem to provide a data communication connection to a corresponding type of communications line 1214. Wireless links may also be implemented, for example as a part of the transmission line 1214 or the networks 1215, 1216. In any such implementation, the communication interface 1213 sends and receives electrical, electromagnetic or optical signals that carry digital data streams representing various types of information.

The network link 1214 typically provides data communication through one or more networks to other data devices. For example, the network link 1214 may provide a connection to another computer through a local network 1215 (e.g., a LAN) or through equipment operated by a service provider, which provides communication services through a communications network 1216. The local network 1214 and the communications network 1216 use, for example, electrical, electromagnetic, or optical signals that carry digital data streams, and the associated physical layer (e.g., CAT 5 cable, coaxial cable, optical fiber, etc). The signals through the various networks and the signals on the network link 1214 and through the communication interface 1213, which carry the digital data to and from the computer system 1201 may be implemented in base band signals, or carrier wave based signals. The base band signals convey the digital data as un-modulated electrical pulses that are descriptive of a stream of digital data bits, where the term “bits” is to be construed broadly to mean symbol, where each symbol conveys at least one or more information bits. The digital data may also be used to modulate a carrier wave, such as with amplitude, phase and/or frequency shift keyed signals that are propagated over a conductive media, or transmitted as electromagnetic waves through a propagation medium. Thus, the digital data may be sent as un-modulated base band data through a wired communication channel and/or sent within a predetermined frequency band, different than base band, by modulating a carrier wave. The computer system 1201 can transmit and receive data, including program code, through the network(s) 1215 and 1216, the network link 1214 and the communication interface 1213.

Moreover, the network link 1214 may provide a connection through a LAN 1215 to a mobile device 1217 such as a personal digital assistant (PDA) laptop computer, or cellular telephone.

By way of a specific example, an application program running on the processor 1203, e.g. a spreadsheet, is processing a document shown on the display 1210 under the control of a user operating the pointing device 1212 and the keyboard 1211. Preferably within such application, the integration code detects a character string in the document associated with a telephone number and a particular Telecommunications Services Provider 1218, then queries the user through e.g. highlighting the character string so that the user can activate the label (having a smart tag feature) associated (previously or currently) with the character string to send a request for data related to an indicated service to the Telecommunications Services Provider 1218 whose telephone number or other address is associated with the character string by the label, and then the Telecommunications Services Provider 1218 sends current data as requested, which is then preferably displayed and/or inserted in the document.

FIG. 3 is a screenshot taken from the display 1210 of FIG. 1, with the telephone directory smart tag feature shown. The result from the search oh the phone number provides various text information that is common with a typical telephone directory search. The document has one or more character strings with a tag having some intelligence attribute, that is, smart tag features. To the right of the screen is a research or resource pane or window of a specific Telecommunications Services Provider 1218 that was obtained by clicking on a character string within the document that has a label associated with the Telecommunications Services Provider 1218, of FIG. 1.

The smart tag feature of the present embodiment is provided by a browser plug-in that recognizes a specific character stream, e.g. words and/or phrases, on a displayed document and automatically turns them into links via telecommunications to a Telecommunications Service Provider 1218, particularly through the use of a telephone number or address of the Telecommunications Service Provider 1218. In this example, the Telecommunications Services Provider 1218 is “Telenor”

Additional functionality is added, namely the menu items shown in the resource window to the right of the screenshot of FIG. 3, which include: 1) “Insert in Document”—this will cut & paste the resulting address text information directly into the document having the smart tag feature, for example a Word document, without a user having to retype the same text information; and 2) “Map It”—a web service that will open up IE (Internet Explorer), or other browser, and graphically map the location of the address that came form the search result. Thereby updated directory search information is provided to a document within the document processing application.

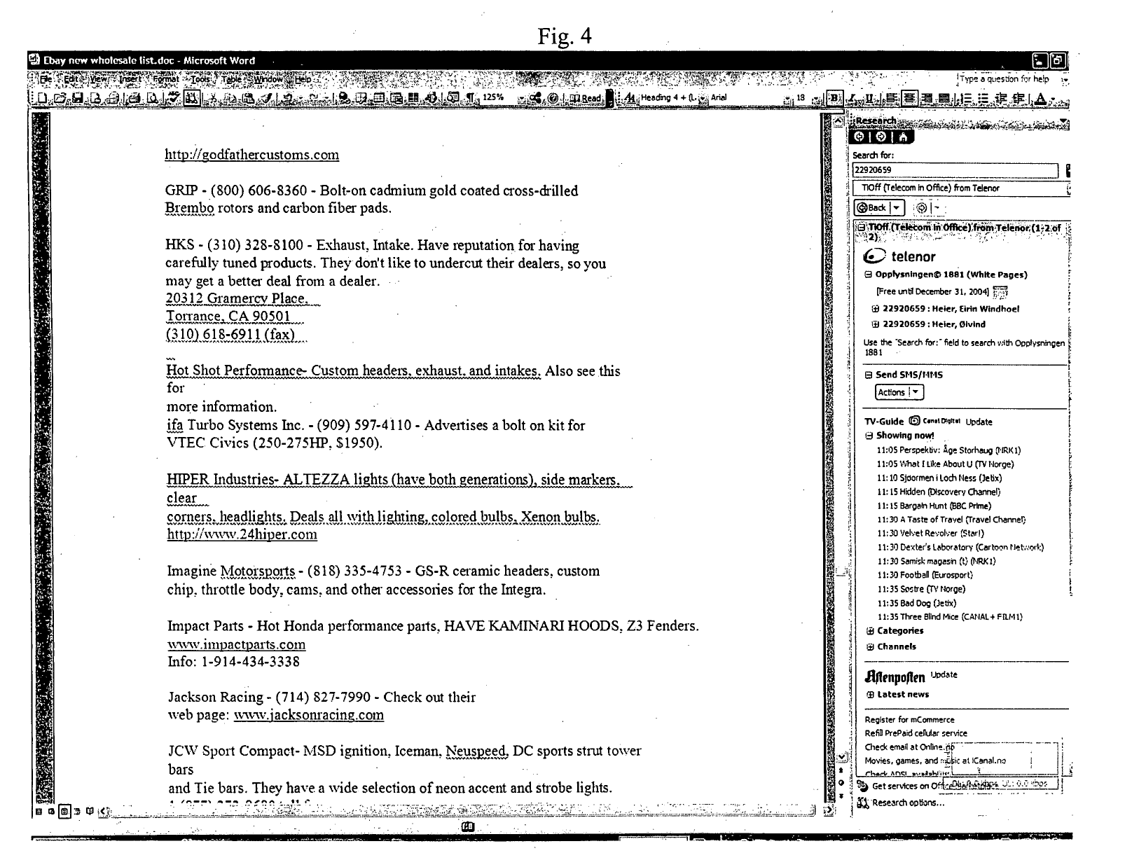

FIG. 4 is a screenshot taken from the display 1210 of FIG. 1, showing a SMS/MMS smart tag feature. This smart tag feature launches the Telecommunications Services Provider's external SMS/MMS application that is preferably not built into the browser plug-in that includes the smart tag features described with respect to FIGS. 3-7. The application will synchronize the user's Contact List with the SMS application providing an easy and user-friendly method of sending a SMS or MMS. The person who shall receive a SMS or MMS is chosen after the smart tag feature has launched the SMS/MMS application.

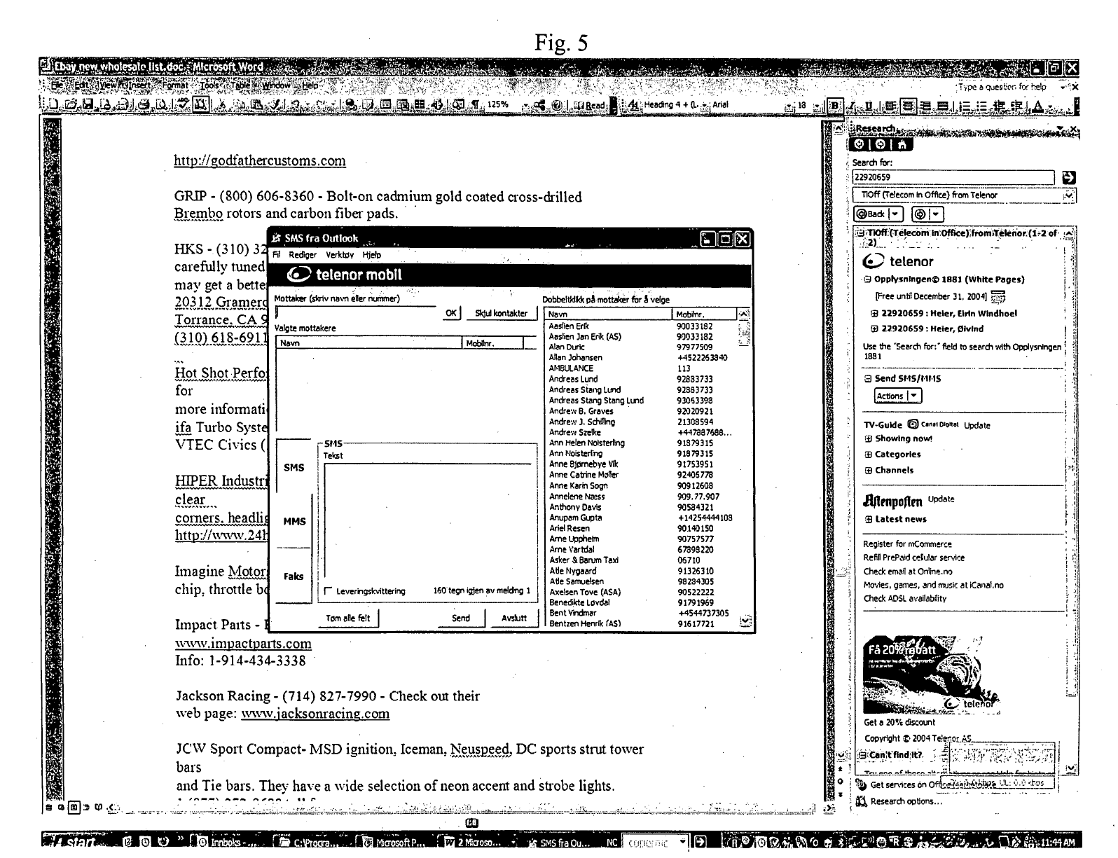

The FIG. 5 screenshot is generated by the browser plug-in after a user has clicked on the menu item “Send SMS/MMS” of the smart tag feature, which is a menu item selectable by the user as set forth above with respect to FIG. 4. This smart tag feature launches a conventional external SMS/MMS application (which is pictured in the center of the screen). From within this browser plug-in application, a SMS/MMS can be sent to any of the contacts listed on the right side of the external application, in a known manner.

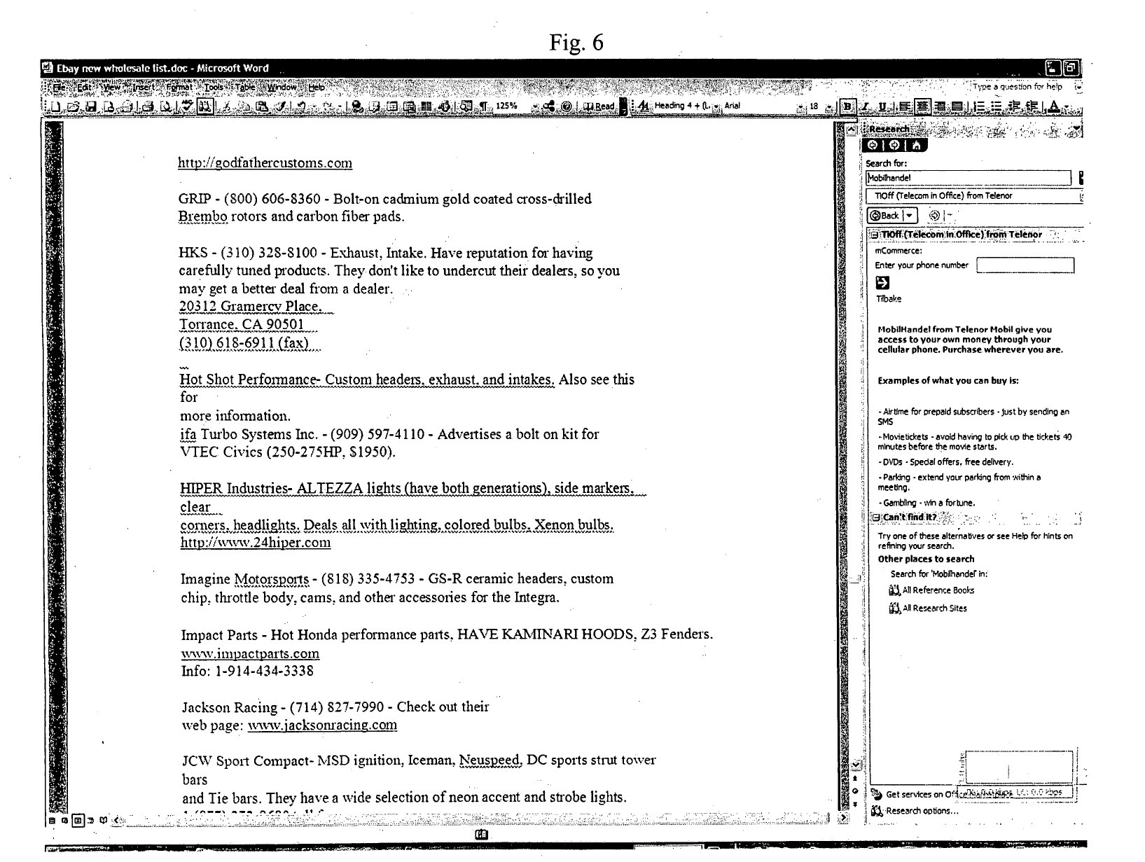

FIG. 6 is a screenshot taken from the display 1210 of FIG. 1, showing the smart tag feature for launching other user menu selectable items, for example: “register for mCommerce”, “Refill PrePaid cellular service”, “Check email at Online.no”, “Movies, games, and music at iCanal.no”, and “Check ADSL availability”. When the user selects the menu option “Register for mCommerce”, this action will launch the Telecommunications Services Provider's 1218 mCommerce service.

The example mCommerce is a subscription service. The mCommerce is the Telecommunications Services Provider's mobile commerce service, which will allow for a mobile subscriber to purchase an item and pay using their mobile subscription as authentication or as a form of payment. The screenshot of FIG. 6 is a picture of the sign-up box for new users who wish to have the service available to them. In the blank box a mobile subscriber would enter their mobile phone number and hit the green arrow. The next screen would provide a message telling the new subscriber that a SMS confirmation to the mCommerce service has been sent to them to begin the sign-up process.

Updated information as to what the subscriber can purchase, particularly categories to be selected for even more detailed information, are a part of the screenshot of FIG. 6.

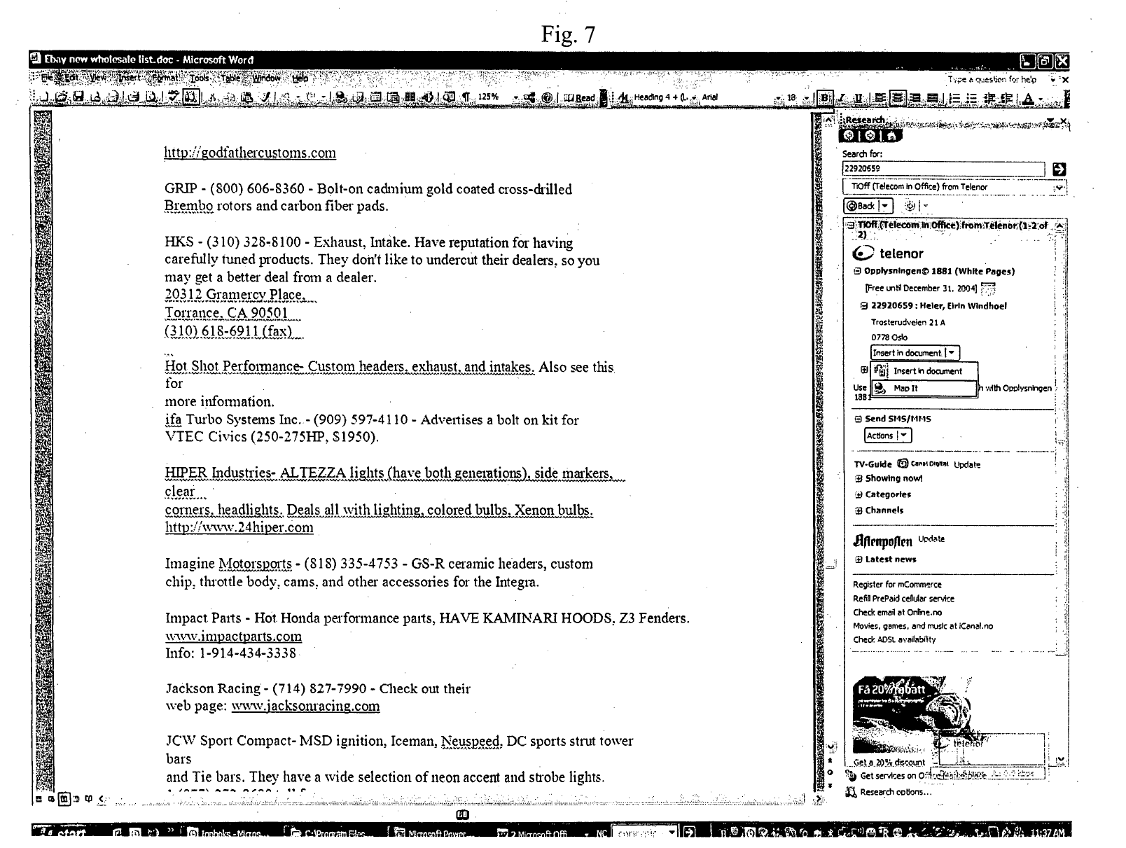

FIG. 7 is a screenshot taken from the display 1210 of FIG. 1, showing the smart tag feature that launches the Telecommunications Services Provider's TV Guide services, which were accessed by a smart tag feature from within an office application running on the computer system 1201 of FIG. 1, particularly during the display of a document (schematically shown in FIG. 1 on Display 1210). This smart tag feature, for example, by selecting the menu item “TV-Guide”/“Showing now” according to a mouse click launches the Telecommunications Services Provider's 1218 TV-Guide service. The TV-Guide service in this screenshot is fully extended to show all the TV shows (and their corresponding channels) that are available at the time the query to the Telecommunications Services Provider 1218 was made. This information is completely updated each time the Telecommunications Services Provider 1218 TV-Guide service is utilized or accessed.

The FIG. 7 screenshot further shows the user selectable menu items “Categories” and Channels, as a part of the TV-Guide service, which if chosen by the user according to, for example, a mouse click launches these additional services under the Telecommnunications Services Provider's 1218 TV-Guide service.

If a user is accessing telecommunications services from within the research pane, which is the XML window, there are two smart tag features embedded within the resource/research pane. One smart tag feature enables a query to a directory database for a user and maps their address. Another smart tag feature will then launch an actual SMS/MMS application. Further, smart tag features that exist within Microsoft Word may be used by the embodiment to look for people's names or numbers in a Word document and from the name and number then launch an SMS or MMS application. Thereby, there are the two places that the embodiment uses smart tag features, within the research pane and within an office application.

The embodiment browser plugin may be implemented in code of less than 10 k, to form no true application, just XML code to launch a current window that exposes existing web services of a Telecommunications Services Provider 1218. Thereby, the action transpires in response to user input, but that action does not take place within the embodiment browser plugin, but rather in known utilities or applications called by the plugin and to which parameters are passed. Actions may actually take place anywhere within the networks 1216 and 1215 or within or at the direction of the Telecommunications Services Provider 1218, because, as previously stated, the plugin is not an application; it is really a window. Although not required, this is preferred to give flexibility to the services and update their handling at central locations rather than at the far more numerous locations of the users.

Numerous modifications and variations of the present invention are possible in light of the above teachings. It is therefore to be understood that within the scope of the appended claims, the invention may be practiced otherwise than specifically described herein.

1. A computer implemented method integrating access to remote telecommunications services with the running of an office application interfacing with a local user performing document processing with the office application, the method being performed within the office application and comprising the steps of:
processing a tag associated with a character string within the document to identify a specific telecommunications services provider; and
in response to said processing, enabling generation of a request for a telecommunications service over a network to the identified telecommunications services provider.

2. The method of claim 1, wherein:
said processing further comprises identifying a character string in the document and tagging the character string to have a smart tag feature associated with the specific telecommunications services provider; and
said enabling includes sending, based on a user input, the tagged character string as a parameter to a communications module.

3. The method of claim 2, wherein said enabling includes sending, based on a user input, stored login information to a communications module.

4. The method of claim 1, wherein said enabling employs one of a Multimedia Message Service (MMS) and a Short Message Service (SMS).

5. The method of claim 1, wherein said processing identifies the character string as one of a phone number, an entity name, an address and a predetermined identifier.

6. The method of claim 1, wherein said processing comprises electronically recognizing a predetermined character pattern within the character string.

7. The method of claim 1, wherein said processing comprises verifying the recognized character pattern with a stored reference character pattern.

8. The method of claim 1, wherein said processing comprises recognizing the character pattern as one of a landline phone number, a cellular phone number, and a net-phone number.

9. The method of claim 1, wherein the office application is one of a word processor, spreadsheet, and presentation applications.

10. The method of claim 1, wherein said processing includes enabling displaying a research pane and said enabling generates a request type in response to user selection of a pre-encoded word from a research pane.

11. The method of claim 10, wherein said enabling displaying shows at least one menu item from among a white pages search, a map-it function, a news function, a television/radio guide, an asymmetric digital subscriber line (ADSL) checking function and a yellow page search.

12. The method of claim 1, wherein said enabling is with respect to the request being a command to initiate a connection between the user's phone and a phone number associated with the character string.

13. A system configured to provide access to telecommunications services from within a computer office application, comprising:
means for tagging a character string in a document being processed by the office application;
means for associating said tagged character string with a specific telecommunications services provider from within the office application; and
means for initiating sending, in response to a user input activating the tagged character string, a request and a parameter associated with the character string to the specific telecommunications services provider from within the office application.

14. The system of claim 13, further comprising means for sending one of the tagged character string and a telecom address corresponding to the tagged character string to the telecommunications services provider.

15. The system of claim 13, further comprising means for sending, based on user input, stored login information to the telecommunications services provider.

16. The system of claim 13, wherein the request is one of a SMS message and a MMS message.

17. The system of claim 13, wherein the character string is one of a phone number, an entity name, an address and a predetermined identifier.

18. The system of claim 13, wherein said means for tagging includes means for electronically recognizing a predetermined character pattern and verifying the recognized character pattern with a stored reference character pattern.

19. The system of claim 13, wherein said character string is one of a landline phone number, a cellular phone number and a net-phone number.

20. The system of claim 13, wherein the office application is one of a word processor, a spreadsheet and a presentation package.

21. The system of claim 19, wherein said means tagging includes means for automatically recognizing the presence of a pre-encoded in a word processing document; and further comprising
means for user selection of a pre-encoded word from a research pane.

22. The system of claim 21, wherein said means of user selection comprises a drop down menu.

23. The system of claim 13, wherein said request initiates connection between a user's phone and a phone number associated with the character string.

24. A computer readable media holding instructions executable to enable a computer-based device to perform the method of claim 1.

25. A computer readable media holding instructions executable to enable a computer-based device to perform the method of claim 2.

26. A computer readable media holding instructions executable to enable a computer-based device to perform the method of claim 5.

27. A computer readable media holding instructions executable to enable a computer-based device to perform the method of claim 7.

28. A computer readable media holding instructions executable to enable a computer-based device to perform the method of claim 8.

29. A computer readable media holding instructions executable to enable a computer-based device to perform the method of claim 9.

30. A computer readable media holding instructions executable to enable a computer-based device to perform the method of claim 10.

31. A computer readable media holding instructions executable to enable a computer-based device to perform the method of claim 11.

32. A computer implemented method integrating remote telecommunications services with an office application while interfacing with a local user performing document processing with the office application, the method being performed within the office application and comprising the steps of:
displaying the document to the user simultaneously with a resource window that includes user selectable services of a specific telecommunications services provider; and
in response to selection of a service from the resource window by the user, generating a request for a corresponding telecommunications service over a network to the specific telecommunications services provider.

33. The method of claim 32, further comprising providing a unique smart tag feature associated with each of the displayed user selectable services.

34. The method of claim 32, wherein the office application is one of a word processor, spreadsheet, and presentation applications.

35. The method of claim 32, further comprising sending the request to the telecommunications services provider over the Internet.

36. The method of claim 35, further comprising providing a unique smart tag feature associated with each of the displayed user selectable services.

37. The method of claim 36, wherein the office application is one of a word processor, spreadsheet, and presentation applications.

38. A computer readable media holding instructions executable to enable a computer-based device to perform the method of claim 32.

39. A computer readable media holding instructions executable to enable a computer-based device to perform the method of claim 33.

40. A computer readable media holding instructions executable to enable a computer-based device to perform the method of claim 34.

41. A computer readable media holding instructions executable to enable a computer-based device to perform the method of claim 35.

42. A computer readable media holding instructions executable to enable a computer-based device to perform the method of claim 36.

43. A computer readable media holding instructions executable to enable a computer-based device to perform the method of claim 37.
